(19) United States
(12) Patent Application Publication
(10) Pub. No.: US 2004/0009099 A1
(43) Pub. Date: Jan. 15, 2004

(54) Automatic immunoassay apparatus

(75) Inventors: Karine Bizet, Boulogne (FR); Bruno Vallayer, Bordeaux (FR); Maurice Vattaire, Auvers Sur Oise (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: BertinTechnologies

(21) Appl. No.: 10/447,600

(22) Filed: May 29, 2003

Related U.S. Application Data
(63) Continuation of application No. PCT/FR01/03686, filed on Nov. 21, 2001.

(30) Foreign Application Priority Data
Nov. 29, 2000 (FR) FR 00/15701

(51) Int. Cl. G01N 35/00

(52) U.S. Cl. 422/64

(57) ABSTRACT

An immunoassay apparatus is provided comprising coaxial rotating trays (14) supporting reaction dishes (18) and (16) supporting tubes (24) containing samples to be analyzed, means for driving the trays in rotation about a common axis, and means (280 supporting reagents, extending in an arc around the rotating trays.

### CROSS-REFERENCE TO RELATED APPLICATIONS

This application is a continuation of PCT Application No. PCT/FR01/03686, filed Nov. 21, 2001, which is hereby incorporated herein in its entirety by reference.

The present invention relates to an automatic apparatus for assaying different substances in biological or chemical samples using known assay methods, for example of the ELISA type.

Apparatus of that type is known, in which samples to be analyzed, reagents and reaction cells are carried by different plates rotatably mounted about vertical axes and generally disposed in a triangle, the plates for the samples and reagents being external to the plate for the reaction cells and broadly tangential or adjacent thereto. Pivoting arms are arranged between the sample and reagent plates and the plate for the reaction cells to take pre-determined quantities of samples and reagents and to deposit them in reaction cells carried by the corresponding plate. Stepwise rotation of that plate allows the reaction cells to run in succession past sample and reagent loading stations then to stations for heating and for regulating the temperature, rinsing, depositing the substrate, reading the results and possibly washing the reaction cells, the apparatus being controlled by a computer to carry out pre-programmed analysis cycles, corresponding to single-reagent or twin-reagent assays.

Known apparatus are complex and bulky and are in general designed to repeatedly carry out a small number of different assays at a high speed on a large number of samples. Because of their bulk and complexity, they are permanent fixtures and are not intended to be transported or moved except under exceptional circumstances.

The aim of the invention is to provide an apparatus of that type, with a relatively small bulk, which can be moved or transported, which is adaptable to any type of assay and which can nevertheless function at high speed to carry out a relatively large number of different assays on a relatively small number of samples, or a relatively small number of different assays on a relatively large number of samples.

To this end, the invention provides an automatic apparatus for assaying substances in biological or chemical samples, comprising means for supporting reagents, means for supporting samples to be analyzed, means for supporting reaction cells, means for taking reagents and samples and for injecting said samples into the reaction cells, means for rinsing the reaction cells, and means for optically measuring the results, characterized in that the sample support means and the reaction cell support means are coaxial rotatable plates and in that the taking and injection means are carried by a radial arm extending between the common axis of the plates and their periphery and are displaceable in translation along said arm, the latter being displaceable in rotation about the axis of the plates.

Mounting the sample and reaction cell support plates about the same axis of rotation means that the overall bulk of the assay apparatus can be substantially reduced. Disposing the taking and injection means on a radial arm that extends between the common axis of the rotatable plates and their periphery means that samples and reagents can be easily and rapidly removed to deposit them in the reaction cells without increasing the bulk of the apparatus. Further, because of this mounting, the plates and the radial arm of the taking and injection means can be carried by the same central tube which defines the axis of rotation of the plates; its upper extremity supports said radial arm.

Displacement of the radial arm in rotation about the axis of the plates can speed up sample and reagent removal along with their deposition in the reaction cells.

For the same reason, it is advantageous for the radial arm to carry two taking and injection units, each mounted on a carriage that is guided in translation on one side of the radial arm, and means for displacing the two carriages independently of each other on the radial arm.

To take samples and reagents, each removal and injection unit comprises controlled means for displacing a needle carrier in vertical translation on the corresponding carriage.

In a preferred embodiment of the invention, the reaction cells are constituted by bars each formed with a pre-determined number of reaction wells aligned in a longitudinal direction of the bar, and the support plate for said bars comprises means for radial and angular positioning and for immobilizing said bars with respect to the common axis of the plates.

Preferably, the bars are carried by supports in the form of a sector of a circle, and comprise means, for example of the snap fit type, for affixing them to the rotatable plate or to the hub of said rotatable plate. This facilitates initial positioning of the bars and their replacement.

In accordance with a further characteristic of the invention, the plate supporting the bars comprises means for individually heating and regulating the temperature of the bars comprising, for example, electrical resistances placed on the walls of the wells of the bars, and controlled means for supplying said resistances with electricity.

Individual heating and temperature regulation of the bars means that their heating cycles can be adapted to the assays to be carried out, which may differ from one bar to another.

In a yet still further characteristic of the invention, the support plate for the samples to be analyzed comprises, at its radially outer periphery, means for receiving tubes or the like for receiving the samples to be analyzed, said tubes being distributed over the plate along at least an arc of a circle.

With respect to the common axis of the plates, said tubes are radially outwardly of the reaction bars.

The reagent support means are fixed and disposed in an arc of a circle about the support plates for the samples to be analyzed and for the reaction cells.

Because of the nature of the reagents, said support means are provided with cooling means, enabling the temperature of the reagents to be kept at a suitable temperature below ambient temperature.

The rotational movements of the plates and the radial arm are controlled by data processing means of the micro-computer type, which are programmed to optimize taking and injection of samples and reagents as a function of the number and nature of the assays to be carried out, and to pass the reaction cells through the reading means at the end of the assay reaction without wasting time. The reaction cells are brought to the means for reading the results, not in the order in which they appear on their support plate, but in the order in which the assay reactions carried out in the cells are completed. This increases the speed of the apparatus of the invention.

The means for reading the results of the assays are optical in nature and comprise different systems, for example one for measuring the light absorption of the contents of the reaction cells at pre-determined wavelengths, another for measuring the chemiluminescence of the contents of said cells, and another for measuring the light emission following excitation of the contents of the cells with light (fluorescence).

One or other of said reading systems is used, depending on the nature of the assays the results of which are to be recorded.

Further, the apparatus of the invention can also be used in association with other measuring apparatus, for example of the flow cytometry or HPLC (high performance liquid chromatography) type, the apparatus of the invention serving to prepare mixtures of cells which are then analyzed by the associated apparatus.

In a further, particularly advantageous aspect of the invention, the reaction bars are characterized in that certain wells in each bar are closed and sealed by a removable closure and contain pre-determined quantities of specific reagents for assaying at least one sample in the other wells of the bar. To use said bars, the closures sealing the wells containing the reagents need only to be removed and the bars placed on the corresponding support plate in the apparatus of the invention.

For each assay, the reagents are taken from the corresponding wells of the bar and deposited in the adjacent wells with the samples to be analyzed.

The invention will be better understood and other details, advantages and characteristics thereof will become clear from the following description, made by way of example with reference to the accompanying drawings in which:

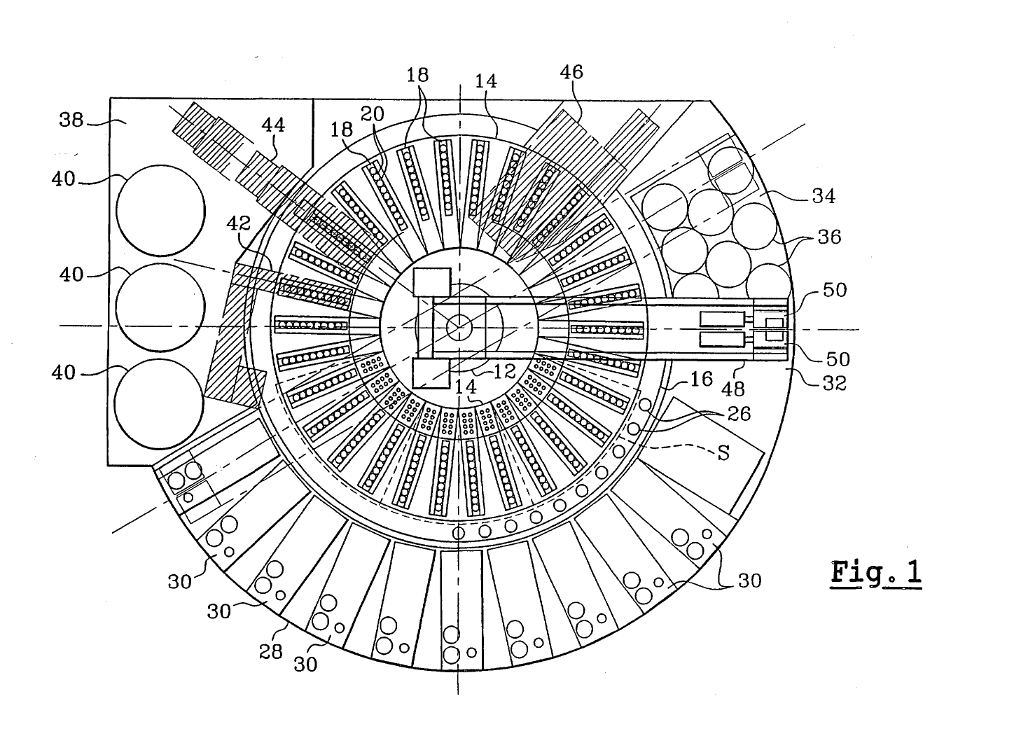

FIG. 1 is a diagrammatic top view of an apparatus of the invention;

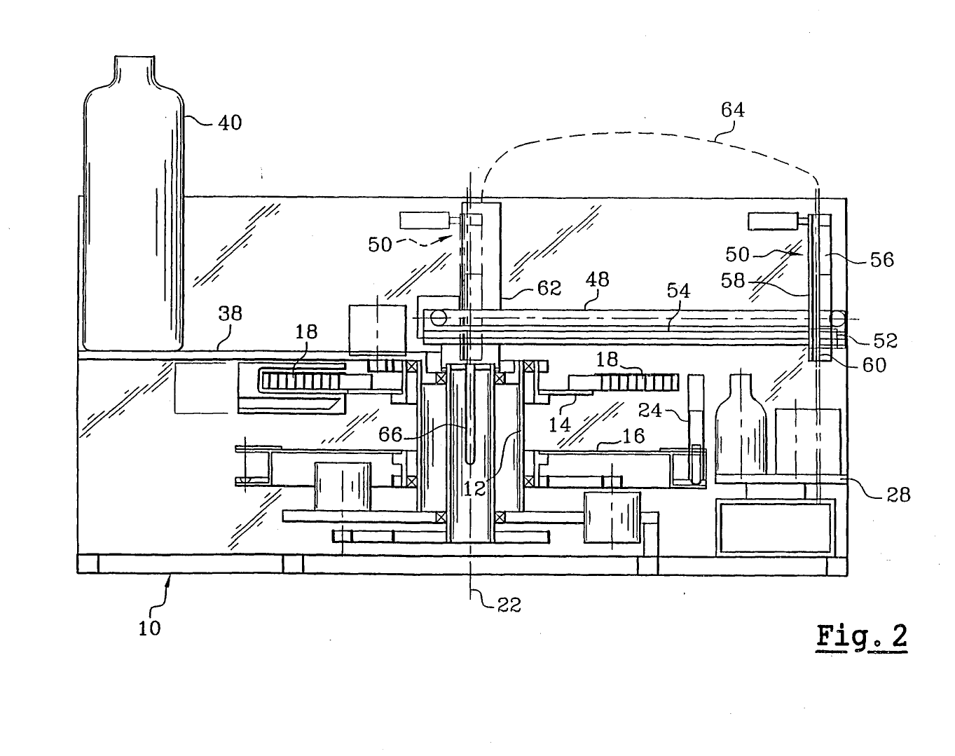

FIG. 2 is a diagrammatic axial cross section of said apparatus;

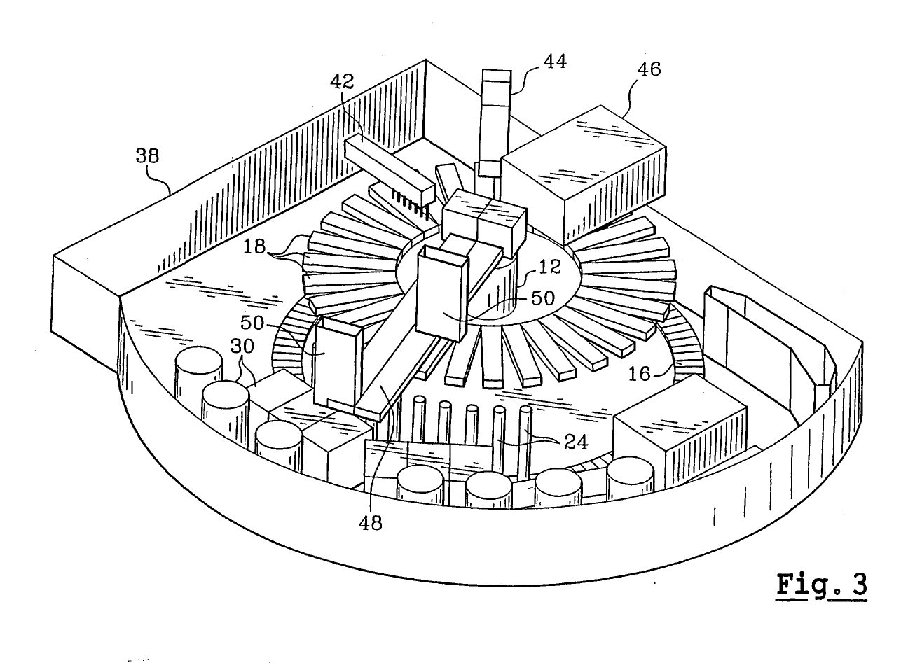

FIG. 3 is a diagrammatic perspective view of said apparatus.

The assay apparatus of the invention shown in the drawings comprises a chassis 10 formed from mechanically welded tubes, which carries a central vertical tube 12 on which two axially spaced plates 14, 16 are mounted and guided in rotation using roller bearings.

The upper plate 14 is intended to support assemblies of reaction cells which are formed by bars 18 each comprising a plurality of reaction wells 20 aligned in the longitudinal direction of the bar, the number of wells per bar being eight in this example.

The bars 18 are radially positioned on the plate 14 with respect to the common axis 22 of rotation of plates 14 and 16 and are held in position by leaf spring means.

Preferably, the surface of the plate 14 is divided into a certain number of circular sectors which are independent of each other and which are fixed on the hub of the plate 14, for example by an elastic snap fit or the like.

In a variant, the bars 18 are removably positioned and fixed on supports in the form of circular sectors which are removably positioned and fixed on the plate 14. At the same time as the bars 18, consumable implements such as flared tubes for taking and injection can be placed on said supports, each intended to be used once to take a sample and deposit it in a well of a bar 18 and which are discarded after use. Said removable supports S can each carry 4, 6 or 8 bars 18 and the corresponding consumable implements, for example, and are diagrammatically represented by the dotted lines in FIG. 1.

The lower plate 16 is intended to support the samples to be analyzed, contained in the liquid form in tubes 24 which are received in supports 26 arranged at the outer periphery of the plate 16 and distributed in an arc of a circle, the tube supports 26 being 10 in number in the example shown in FIG. 1.

Plates 14 and 16 are driven in stepwise rotation about axis 22 independently of each other using timing belts driven by electric motors.

One surface 28 of the reagent support is fixedly mounted on the chassis 10 and extends in an arc of a circle over about 180° about the axis 22, radially outwardly of the plate 16 and substantially at the same level thereof. This surface 28 is intended to carry a certain number of assemblies 30 of reagents, each corresponding to a different assay to be carried out on the samples to be analyzed. The surface 28 can also include a zone 32 for receiving samples to be analyzed and a zone 34 for supporting flasks 36 which may contain substrates, antibodies, serums, etc, inter alia.

The portion of the surface 28 that supports the assemblies 30 of reagents is provided with cooling means which can keep the reagents at a pre-determined temperature, for example 4° C.

At one extremity of the surface 28 is a further support surface 38 carried by the chassis 10 on which flasks 40 of rinsing or washing liquid can be deposited, which can supply a fixed rinsing head 42 that extends radially above the path of the reaction bars carried by the plate 14.

The surface 38 also supports a system 44 for optically reading the assay results by measuring the light absorption at certain wavelengths by the contents of the wells 20 in the reaction bars, said reading system 44 being followed by a further system 46 for reading the results by measuring the chemiluminescence of the liquids contained in the wells of the reaction bars 20.

A further system for reading the results by measuring fluorescence can be provided in the apparatus of the invention in addition to systems 44 and 46 or instead of one or the other, said further system comprising means for exciting the contents of the reaction cells with light and means for measuring the light emission resulting from said excitation.

A radial arm 48 is rotatably mounted on the upper extremity of the central tube 12 and extends horizontally between the axis of rotation 22 and the periphery of the apparatus. Said arm 48 carries two taking and injection units 50 which can be displaced independently of each other in translation along the arm 48. Each unit 50 comprises a carriage 52 guided in translation on a horizontal rail 54 of the arm 48 and driven by an electric motor. Each carriage 52 comprises a vertical upright 56 carrying a rail 58 guiding a needle carrier 60 which is displaceable in translation on the rail 58 by an electric motor.

At its extremity located at the level of the axis of rotation 22, the arm 48 is integral with a vertical plate 62 which supports a linear syringe-plunger type actuator, as well as a syringe and an electronic valve connected via tubes 64 to needles 60 of said removal and injection units 50. In conventional manner, a drive liquid is contained in the syringe, the electro-valve and a portion of tubes 64, which allows small accurately determined quantities of liquid to be taken and injected via the needles. A central well 66 allows the needles 60 to be cleaned after each use.

The radial arm 48 is driven in rotation by an electric motor and a timing belt.

The reaction bars 18 which are used in the apparatus of the invention are produced from glass or transparent plastics material to enable the assay results to be read optically.

Said bars can be re-usable following washing and decontamination, or they can be disposable following a single use.

To facilitate and simplify the use of the apparatus of the invention, the reaction wells 20 can undergo a treatment which renders them specific for the substances to be detected, said treatment comprising, for example, depositing a coating of an antibody on the internal wall of the reaction wells 20.

Further, the reaction bars comprise individual heating and heat regulation means comprising electrical resistances formed by wires or films deposited on or bonded to the outer lateral surface of said wells. The means provided on the plate 14 for positioning and immobilizing the bars comprise automatic means for supplying electricity to the bar well heating resistances, for individual heating and temperature regulation of each bar.

In a particular embodiment, each reaction bar can comprise a certain number of bars which serve to store reagents specific for one or more particular assays. As an example, four wells of a bar comprising eight reaction wells can contain pre-determined quantities of reagents specific for a given assay and are closed and sealed by a removable or tearable closure. For use, said bars are placed on the plate 14 after removing or tearing off said closures.

The apparatus described above functions as follows:

The reagents corresponding to the assays to be carried out are placed on the surface of support 28 around plates 14 and 16. Reaction bars 18, preferably new, are placed on the plate 14. Samples to be analyzed are contained in tubes 26 placed in recesses 24 in the lower plate 16. Starting up the apparatus, which is computer controlled, allows units 50 to take pre-determined quantities of samples from tubes 26 and reagents from assemblies 30 and deposit them in the wells of the reaction bars. The sample tubes 26 are labeled and identified with bar-coded labels which can be read by a scanner mounted adjacent to the periphery of the plate 16. The reaction bars 18 are identified by their angular position with respect to a radial reference mark on the plate 14; these positions are numbered 1 to 30 in the example shown.

The two taking units 50 mounted on the arm 48 speed up the deposition of samples and reagents in the wells of the reaction bars as follows: when unit 50 is used to take a sample or a reagent and to deposit it in a reaction well, the other unit is displaced towards the axis 22 to clean its needle. Then, this other unit 50 is used to take and deposit and the first unit 50 is displaced towards the axis 22 to clean its needle. Each time the roles of the units 50 are reversed, the plate 14 is displaced in rotation in one direction, and then in the other, to place the wells of a bar 18 in radial alignment with the needle 60 of the unit 50 used to deposit a sample or a reagent. Rotation of plates 14 and 16 can bring the bars and samples into alignment. During the assay reactions, the temperatures of the bars 18 are regulated bar by bar.

At the end of the reaction, by rotating the plate 14, each bar is brought in front of the reading means 44 or 46 in the order in which the reactions in the wells of the bars are completed.

The apparatus of the invention can also be used with other means for measuring the results, for example with cytometric or chromatographic measuring means. It then essentially serves as an apparatus for preparing mixtures of cells and is associated via the taking and depositing means either to an HPLC (high performance liquid chromatography) or to a flow cytometry type apparatus. In known manner, such a system allows the study and characterization of cells after labeling with fluorescent markers and comprises flexible means for presenting the cells one by one to optical detection means associated with means for light excitation (for example a laser) and with means for processing the signals and data.

Three types of signals are measured:

light diffraction at small angles (1° to 20°), providing information regarding cell size and their refringence (dead or live cells);

light diffraction at 90°, providing information regarding the internal contents of the cells;

spontaneously emitted fluorescence and/or fluorescence emitted after labeling with a fluorescent probe.

1. An apparatus for assaying substances in biological or chemical samples, comprising means for supporting reagents, means for supporting samples to be analyzed, means for supporting reaction tubes, means for taking reagents and samples to be analyzed and for injecting said reagents and samples into the reaction tubes, and means for optically measuring the results, characterized in that the sample support means and the reaction tube support means are coaxial rotatable plates and in that the taking and injection means are carried by a radial arm extending between the common axis of the plates and their periphery and are displaceable in translation along said arm, the latter being displaceable in rotation about the common axis of the plates.

2. An apparatus according to claim 1, wherein the radial arm carries two taking and injection units, each mounted on a carriage that is guided in translation on one side of the radial arm, and means for displacing the two carriages independently of each other on the radial arm.

3. An apparatus according to claim 2, wherein each taking and injection unit comprises controlled means for vertical translation on the corresponding carriage.

4. An apparatus according to claim 1, wherein the reaction cells comprises bars each formed with a pre-determined number of reaction wells aligned in a longitudinal direction of the bar, and wherein the support plate for said bars comprises means for radial and angular positioning and for immobilizing said bars.

5. An apparatus according to claim 4, wherein the bars are carried by supports in the form of a sector of a circle, comprising fixing means for affixing them to the rotatable plate or to the hub of said rotatable plate, and optionally carrying consumable implements.

6. An apparatus according to claim 4, wherein the bar support plate comprises means for individually heating and regulating the temperature of the bars, constituted by electrical resistances placed on the walls of the wells of the bars, and by controlled means for supplying said resistances with electricity.

7. An apparatus according to claim 1, wherein the rotational movements of the plates and the radial arm are controlled by data processing means which are programmed to optimize taking and injection of samples and reagents and to bring the reaction cells to the means for optically reading the results in the order in which the assay reactions are completed.

8. An apparatus according to claim 1, wherein the support plate for the samples to be analyzed comprises, at its radially outer periphery, means for receiving tubes or the like for receiving samples to be analyzed, said tubes being distributed on the plate along an arc of a circle radially outwardly of the plate carrying the reaction cells.

9. An apparatus according to claim 8, wherein the plates supporting the reaction bars and the samples to be analyzed are axially offset on their common axis.

10. An apparatus according to claim 1, wherein the reagent support means are fixed and disposed in an arc of a circle radially outwardly of the plates supporting the reaction cells and the samples to be analyzed.

11. An apparatus according to claim 10, wherein the means supporting the reagents comprise means for cooling the reagents.

12. An apparatus according to claim 1, which comprises a plurality of systems for optically reading the results, by measuring the light absorption of the contents of the reaction cells or wells at pre-determined wavelengths, by measuring the chemiluminescence of the and/or by measuring the light emitted by said contents in response to excitation with light.

13. An apparatus according claim 1, which is associated with a flow cytometry or HPLC type apparatus.

14. A reaction bar for an apparatus of the type described in claim 1, wherein certain wells in each bar are closed and sealed by a removable closure and contain reagents that are specific for assaying at least one sample in the other wells of the bar.
